(19) United States
(12) Patent Application Publication
(10) Pub. No.: US 2012/0097109 A1
(43) Pub. Date: Apr. 26, 2012

(54) LEVER MOUNTED SYSTEM AND METHOD FOR FEEDING AND CLEANING GAME

(75) Inventor: Benjamin Britt Sturgeon, Amarillo, TX (US)

(73) Assignee: EASY LIFT FEEDERS, LLC, Canadian, TX (US)

(21) Appl. No.: 12/908,346

(22) Filed: Oct. 20, 2010

(51) Int. Cl. A01K 5/00

(52) U.S. Cl. 119/51.01

(57) ABSTRACT

A game feeder system is disclosed. Specifically, a game feeder system is disclosed comprising a lever having a first end, a second end, and a fulcrum point. Further, said game feeder system comprises one or more legs each having a first end and second end. The game feeder system also comprises a core attached to said fulcrum point and to said legs.

### BACKGROUND

This disclosure relates to a lever mounted system and method for feeding and cleaning game. For purposes of this disclosure feeding and cleaning of game is discussed. However, such discussion of game is solely exemplary, and not limiting.

Hunting equipment has evolved over the years. In ancient times, hunters were subject to the natural migratory patterns of game. Tracking game along their natural migratory patterns was time consuming and required free movement of the hunters without regard to territorial boundaries such as land ownership or rivers. With the introduction of game feeders, hunters were able to attract game to a fixed location which simplified the process of tracking game. Later, automatic game feeders were introduced capable of spreading feed on a predetermined schedule. As a result of feeding game on a predetermined schedule, hunters were able to alter the natural migration pattern of the game. Consequently, these improvements in hunting equipment have improved the hunter's ability to attract game and influence their migratory patterns.

Various game feeding systems currently exist. In one embodiment, a feed container and broadcaster are hanged from a tree limb with a rope. The feed container is thereby raised and lowered by using the tree limb as a makeshift pulley for the rope. However, in this embodiment, the feeding system can only be used underneath a tree and therefore lacks versatility in areas lacking readily available trees. Further, in this embodiment, the rope may suffer deterioration due to rubbing on the tree's limb. Still further, by hanging a feeder from a tree, pests or rodents (such as squirrels) have easy access to the feeder from their natural nesting location. Further, a full feed container may be too heavy for many individual hunters to lift to a sufficient height to be useful in a tree. In another embodiment, a feed container and broadcaster may be mounted to a feeding stand. For example, a feeding stand may have three or more fixed legs which serve to hold the feed container and broadcaster above the ground and provide a wide spreading radius to the broadcaster. Further, by lifting the broadcaster off the ground pests may have a more difficult time gaining access to the feeder's contents. However, in this embodiment, the feeder container becomes difficult to refill. Once a feeder is elevated, the user must bring a ladder or truck to the location of the feeder to gain access to the feed container. Further, the user must carefully elevate and pour feed into the feed container. In another embodiment, a game feeder apparatus includes a container or drum for storing feed; the container has a bottom panel with a center opening through the bottom panel; a support assembly for supporting the container includes a vertical tub which extends through the center opening; and finally, a winch having a rotatable spool is attached to the support assembly and is used to drive a line attached to the container by a pulley system. Thus, in this embodiment, the container can be raised and lowered along the post via the winch and cable. However this embodiment fails in many crucial aspects. For example, a specialized container must be used which is designed with a center opening. Additionally, this embodiment is not designed to accommodate the cleaning of harvested game. Also, this design is unstable due to its lack of a broad base and is limited to the power of the winch and pulley system used in it.

Likewise, various systems for cleaning game exist. Cleaning game is also known as “field dressing” or “game processing”, and is the process of removing the internal organs and hide of harvested game. Field dressing is a necessary step in preserving meat from animals harvested in the wild. Generally, field dressing must be done as soon as possible in order to ensure rapid body heat loss, and prevent bacteria from growing on the surface of the carcass. Field dressing helps maintain the overall quality of the meat. It also makes it considerably easier for a hunter to carry larger game from the hunt area. Field dressing is often completed at a different location than the site of the kill. In one embodiment, to accommodate the process of removing internal organs, harvested game can have their front legs placed behind its skull and then hung from a tree branch or a “buck pole”. Thereupon, undesirable parts can be removed and the game may be allowed to hang in order to cure the meat before the butchering is done. However, this embodiment has many shortcomings similar to hanging a feed container and broadcaster to a tree limb. For example, this embodiment can only be used underneath a tree and therefore lacks versatility in areas lacking readily available trees or trees outside of the game's migration path. Further, in this embodiment, the rope may suffer deterioration due to rubbing on the tree's limb. Still further, the harvested game may be too heavy for many hunters to lift to a sufficient height to be cleaned.

However, these game feeders and cleaners still remain incomplete in their features. For example, current game feeders are difficult to refill due to the weight of feed and height of the hanging feeder container which holds the heavy feed. Further limitations exist with current game feeders as they are incapable of additional helpful tasks such as cleaning of game which could be accomplished with the same system.

As such it would be useful to have an improved lever mounted system and method for feeding and cleaning game.

### SUMMARY

A game feeder system is disclosed. Specifically, a game feeder system is disclosed comprising a lever having a first end, a second end, and a fulcrum point. Further, said game feeder system comprises one or more legs each having a first end and second end. The game feeder system also comprises a core attached to said fulcrum point and to said legs.

### BRIEF DESCRIPTION OF THE DRAWINGS

FIG. 1 illustrates a lever mounted game feeder.

FIG. 2a illustrates an upper profile view of lever.

FIG. 2b illustrates a detail view of fourth junction assembly, assembled.

FIG. 2c illustrates a detail view of fourth junction assembly, disassembled.

FIG. 3a illustrates a front view of a core.

FIG. 3b illustrates a rear lower view of core.

FIG. 4 illustrate a rear lower view of legs and core.

FIG. 5a illustrates lever mounted game feeder with hanging feeder container assembly in the up position.

FIG. 5b illustrates lever mounted game feeder with game.

FIG. 6 illustrates a detailed view of first chain holding lever mounted game feeder system 100 in the up position.

FIG. 7 illustrates hanging feeder container assembly.

### DETAILED DESCRIPTION

Described herein is a lever mounted system and method for feeding and cleaning game. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

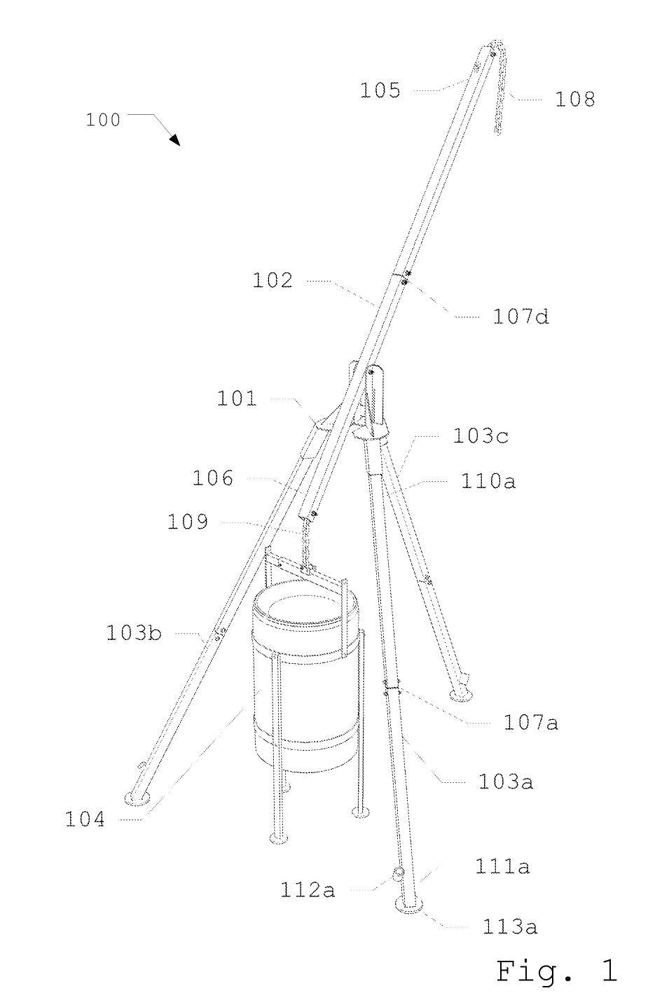

FIG. 1 illustrates a lever mounted game feeder 100. Lever mounted game feeder 100 can comprise a core 101, a lever 102, one or more legs 103, and a hanging feed container assembly 104. Lever 102 can comprise a first end 105, a second end 106, a first chain 108, and a second chain 109. Legs 103 can comprise a first leg 103a, a second leg 103b, and a third leg 103c. Each of legs 103 can comprise a first end 110, a second end 111, an anchor point 112, and a foot 113. For example, a first leg 103a can comprise a first end 110a, a second end 111a, a first anchor point 112a, and a first foot 113a. In one embodiment, anchor point 112 can be attached to each second end 111. In another embodiment, anchor point 112 can be fabricated from metal tubing. In still another embodiment, lever mounted game feeder 100 can be secured to the ground by hammering a stake or peg into the ground through anchor point 112.

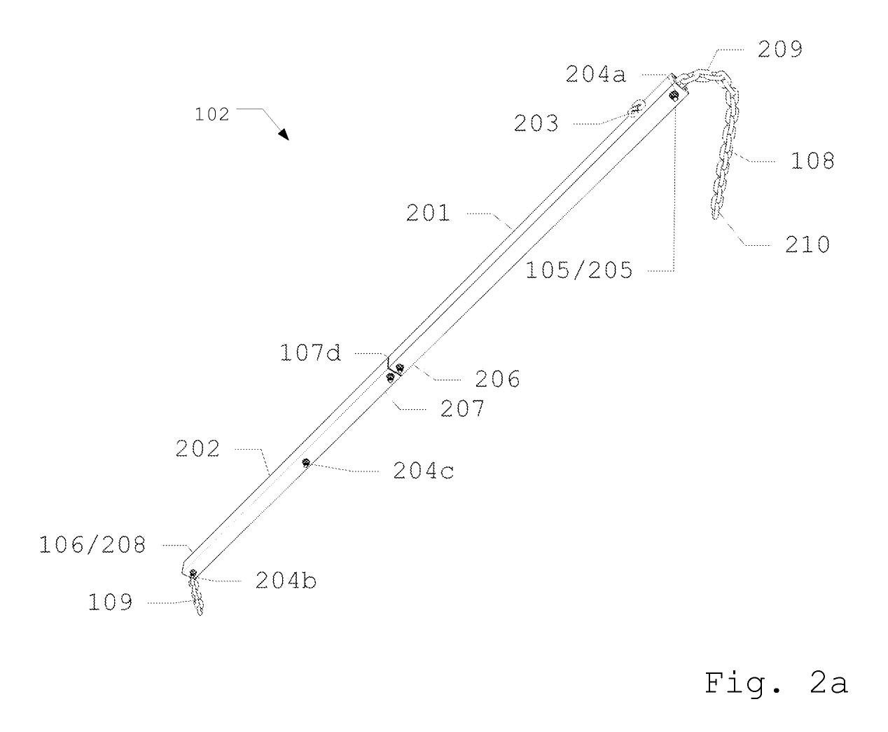

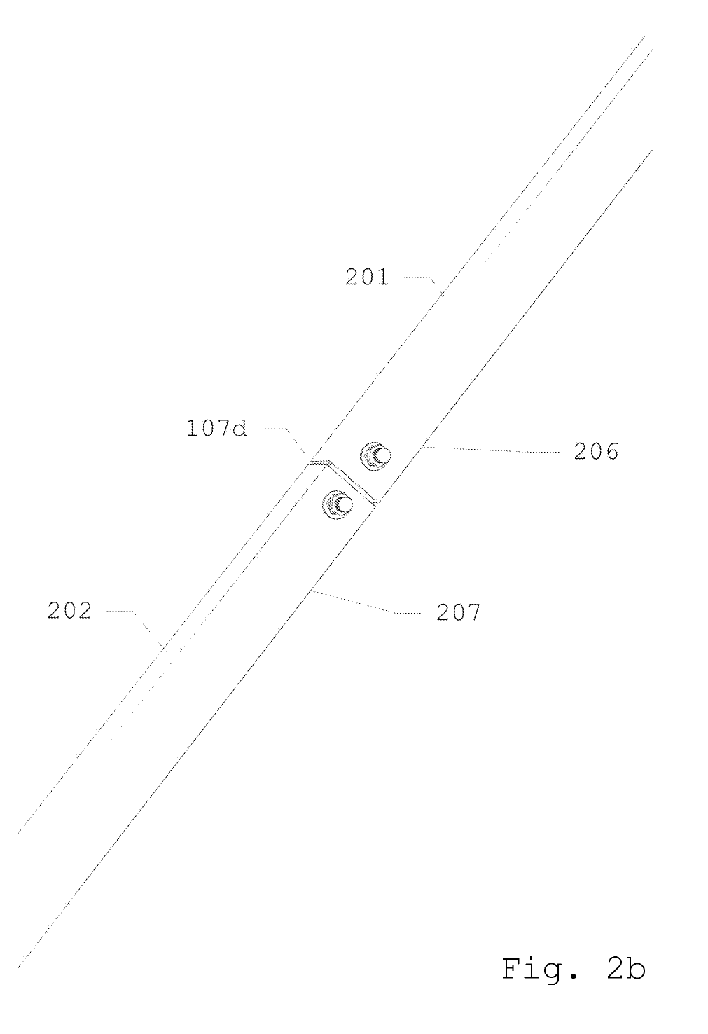

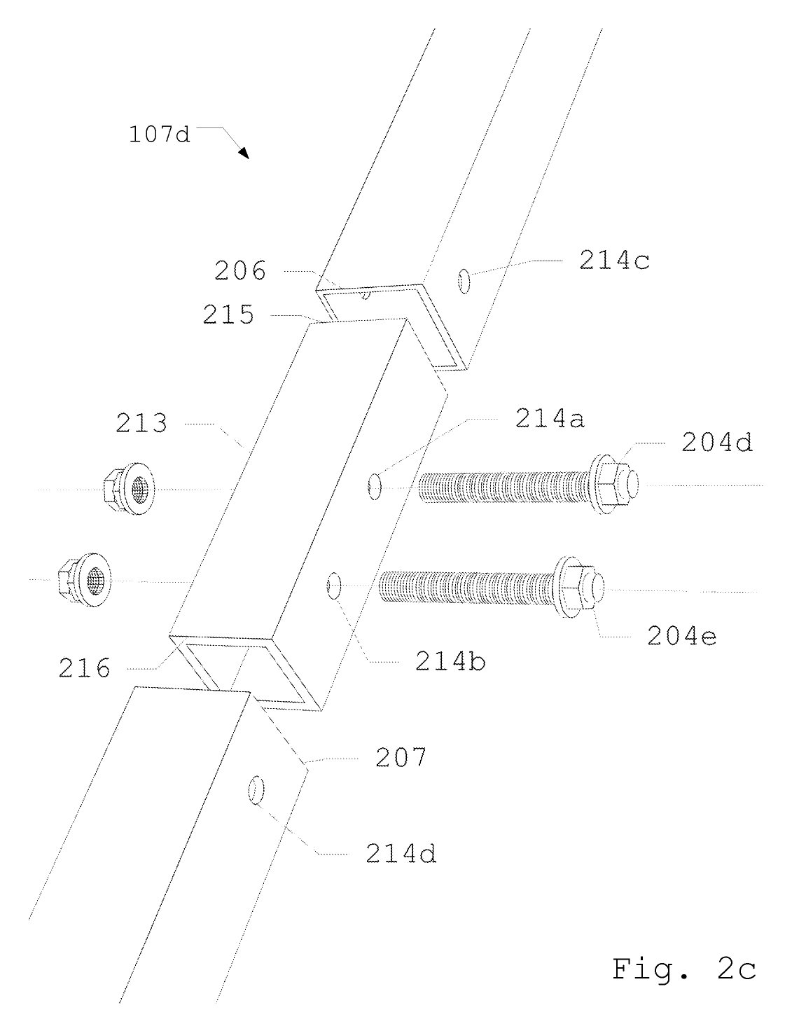

FIG. 2a illustrates an upper profile view of lever 102. Lever 102 can further comprise a first segment 201, a second segment 202, a first hook 203, a fourth junction assembly 107d, and one or more bolt assemblies 204. First segment 201 can comprise a first end 205 and a second end 206. Second segment 202 can comprise a first end 207 and a second end 208. Bolt assemblies 204 can comprise a first bolt assembly 204a, a second bolt assembly 204b, and a third bolt assembly 204c. In one embodiment, lever 102 can comprise one or more sections of rectangular tubing. In one embodiment, where lever 102 comprises rectangular tubing having two long sides and two short sides, lever 102 can be oriented to provide extra lifting strength by aligning the longer sides parallel to the direction of lever 102's lifting motion. In one embodiment, third bolt assembly 204c can serve as a fulcrum, or “pivot point”, for lever 102. In another embodiment, first hook 203 can be attached to first end 105. First chain 108 can comprise a first end 209 and a second end 210. In one embodiment, first chain 108 is attached to first end 205 of lever 102 by inserting a first bolt assembly 204a through first end 209 of first chain 108 and first end 205 of lever 102.

FIG. 2b illustrates a detail view of fourth junction assembly 107d, assembled. FIG. 2c illustrates a detail view of fourth junction assembly 107d, disassembled. Fourth junction assembly 107d can comprise a fourth bolt assembly 204d, a fifth bolt assembly 204e, an internal junction sleeve 213, and one or more junction holes 214. In one embodiment, junction holes 214 can comprise two holes in substantially parallel walls which can be aligned with one another on a single axis. Junction holes 214 can comprise first junction holes 214a, second junction holes 214b, third junction holes 214c, and fourth junction holes 214d. Internal junction sleeve 213 can comprise a first end 215, a second end 216, first junction holes 214a, and second junction holes 214b. Second end 206 can comprise third junction holes 214c. First end 207 can comprise fourth junction holes 214d. In one embodiment, as in FIG. 2c, the internal circumference of the openings at the ends of second end 206 and first end 207 are larger than the external circumference of internal junction sleeve 213. In such embodiment, second end 206 can slide around and over first end 215, and first end 207 can slide around and over second end 216. Further, in one embodiment, first junction holes 214a can be aligned with third junction holes 214c, and second junction holes 214b can be aligned with fourth junction holes 214d. In such embodiment, fourth bolt assembly 204d can be inserted through first junction holes 214a and third junction holes 214c and tightened in order to secure second end 206 to first end 215. Further, in such embodiment, fifth bolt assembly 204e can be inserted through second junction holes 214b and fourth junction holes 214d and tightened in order to secure first end 207 to second end 216. In another embodiment, the exterior circumference of first end 207 is smaller than the interior circumference of second end 206. In such embodiment, first end 207 can be inserted into second end 206, third junction holes 214c can be aligned with fourth junction holes 214d, fourth bolt assembly 204d can be inserted through third junction holes 214c and fourth junction holes 214d and tightened in order to secure second end 206 to first end 207.

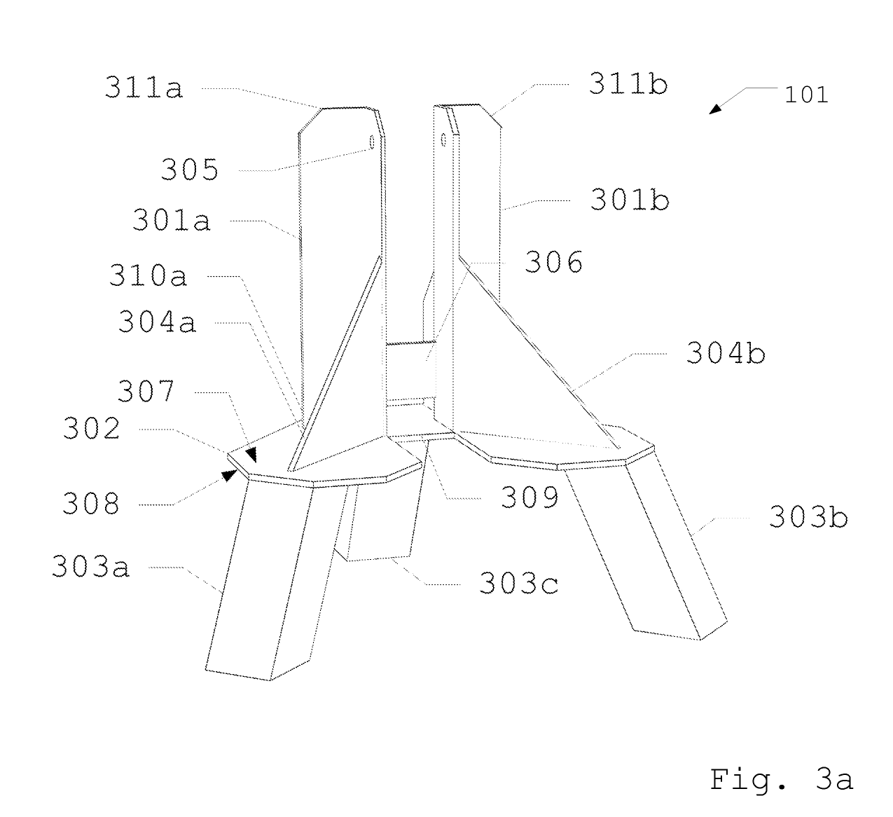

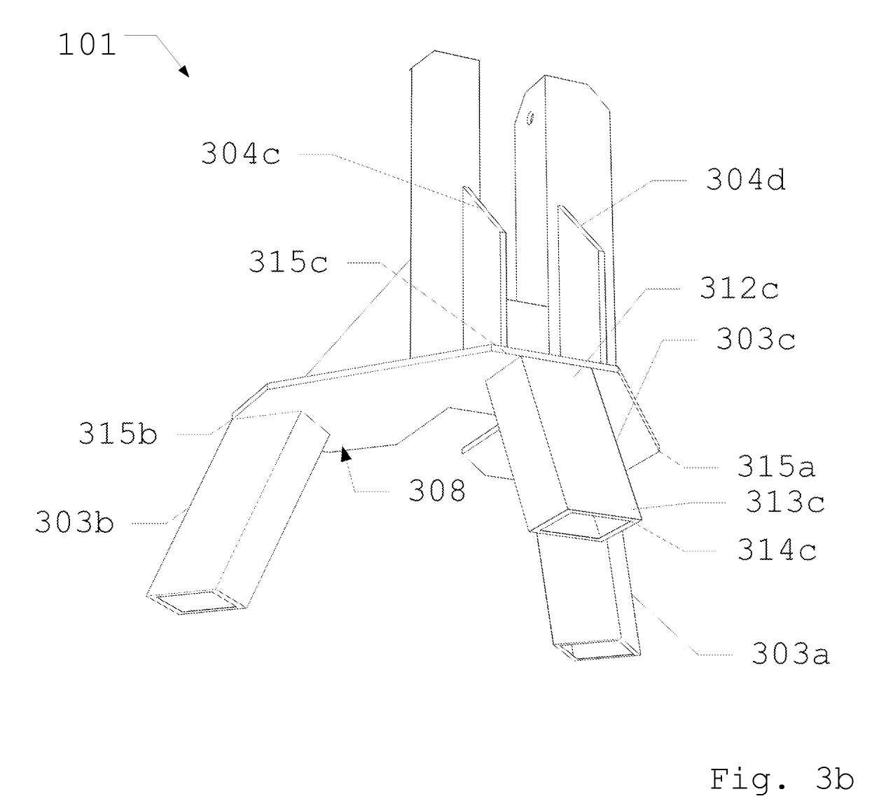

FIG. 3a illustrates a front view of core 101. Core 101 can comprise one or more core towers 301, a core platform 302, one or more core legs 303, one or more gusset plates 304, one or more tower holes 305, and a tower brace 306. Core platform 302 can comprise a platform top 307 and a platform bottom 308. Core platform 302 can comprise a notch 309. Core towers 301 can comprise a first tower 301a and a second tower 301b. Further, each of core towers 301 can comprise a tower bottom 310 and a tower top 311. In one embodiment, a first tower bottom 310a and a second tower bottom 310b can be attached to platform top 307. In one embodiment, core towers 301 can be stabilized by securing them to core platform 302 with a first gusset plate 304a and a second gusset plate 304b. In another embodiment, core towers 301 can be stabilized by attaching first tower 301a to second tower 301b with a tower brace 306. In one embodiment, tower holes 305 can comprise two holes in substantially parallel walls which can be aligned with one another on a single axis. In one embodiment, tower holes 305 are substantially located in first tower top 311a and second tower top 311b. In one embodiment, core 101 and lever 102 are attached to one another by inserting third bolt assembly 204c through tower holes 305 and lever 102. In such embodiment, lever 102 can be used as a lever relative to core 101 with third bolt assembly 204c serving as the fulcrum of the lever mechanism created by the junction of elements in this embodiment.

FIG. 3b illustrates a rear lower view of core 101. Core legs 303 can each comprise a leg top 312, a leg bottom 313, and a leg opening 314. Leg opening 314 can comprise a first leg opening 314a, a second leg opening 314b, and a third leg opening 314c. In one embodiment, each leg top 312 can be attached to platform bottom 308. Platform bottom 308 can comprise a first corner 315a, a second corner 315b, and a third corner 315c. Core legs 303 can comprise a first leg 303a, a second leg 303b, and a third leg 303c. In one embodiment, core legs 303 can be attached and arranged in order to stabilize core 101. In one embodiment, first leg top 312a can be attached to first corner, second leg top 312b can be attached to second corner 315b, and third leg top 312c can be attached to third corner 315c. In one embodiment, core towers 301 can be stabilized by securing them to core platform 302 with a third gusset plate 304c and a fourth gusset plate 304d.

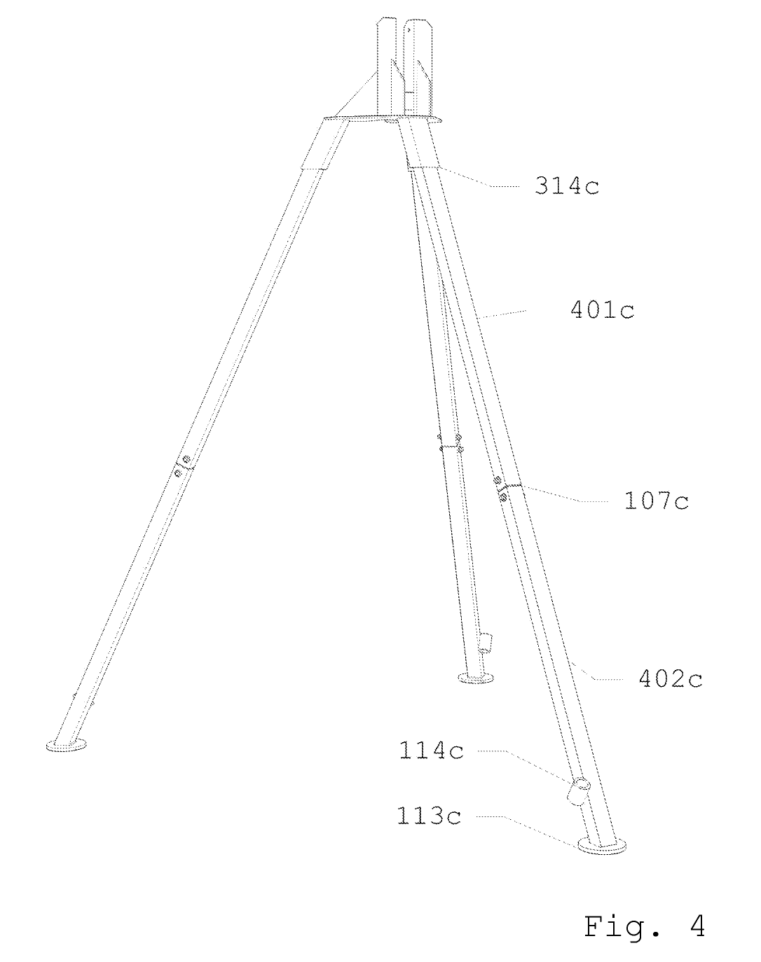

FIG. 4 illustrate a rear lower view of legs 103 and core 101. In one embodiment, the exterior circumference of legs 103 can be smaller than the interior circumference of leg openings 314. In such embodiment, legs 103 can be attached to core 101 by inserting first end 110 into leg opening 314. Each of legs 103 can comprise a first segment 401, a second segment 402, and a junction assembly 107. In one embodiment, legs 103 can be long enough to ensure that animals common to the area of usage cannot reach hanging feeder container assembly 104 when lever mounted game feeder is in the up position.

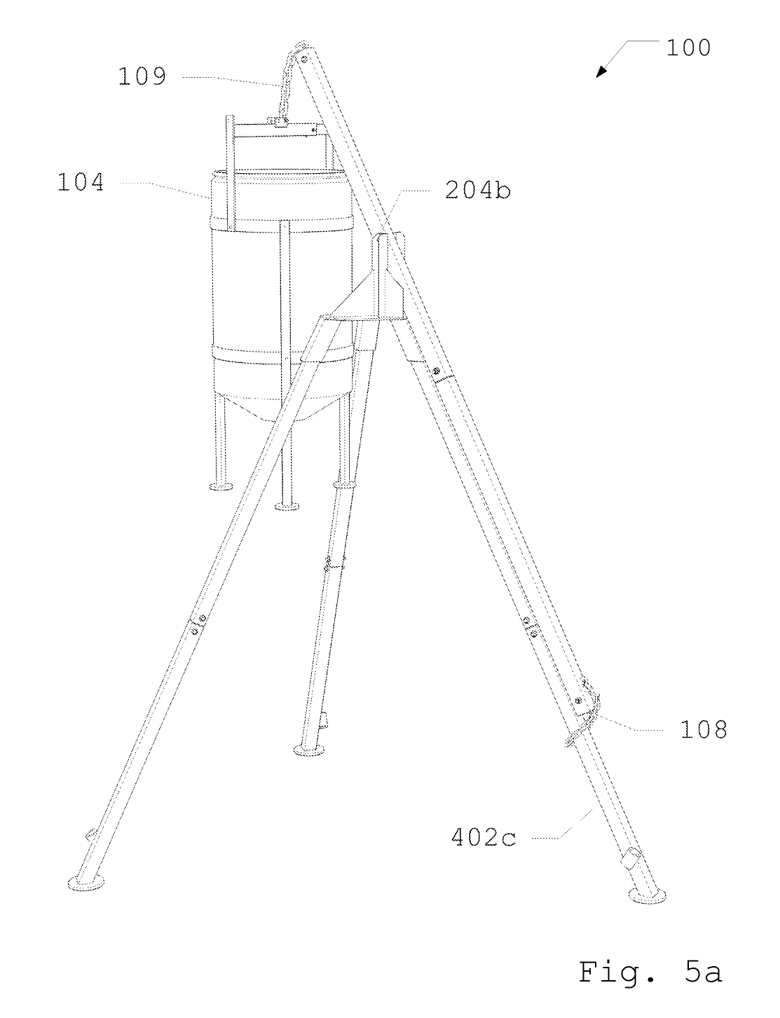

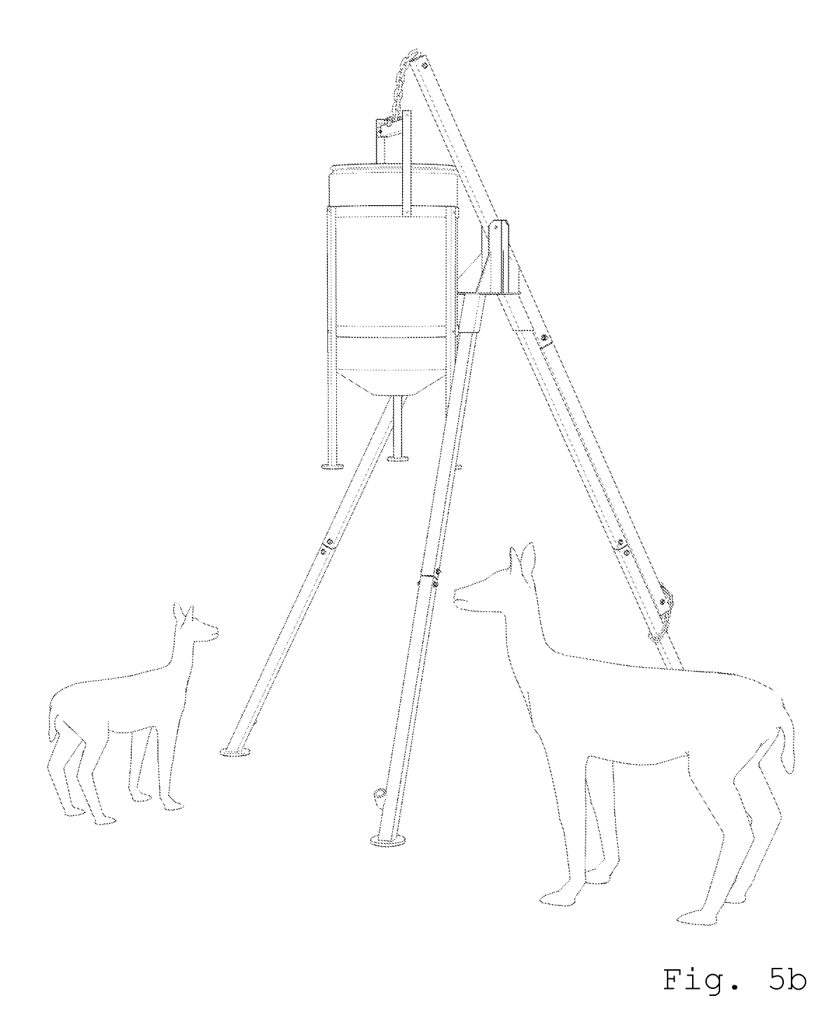

FIG. 5a illustrates lever mounted game feeder 100 with hanging feeder container assembly 104 in the up position. When the user of lever mounted game feeder 100 has attached a load to second chain 109, lever 102 can be raised by pulling down on first end 105. In one embodiment, said load can be a game feeder as known in the art. In another embodiment, said load can be an animal which is ready to be cleaned or gutted.

FIG. 5b illustrates lever mounted game feeder 100 with game. In one embodiment, the game can be animals frequently hunted such as deer, birds, or hogs. In another embodiment, lever mounted game feeder 100 can be positioned above a body of water containing fish. In such embodiment, the game can be fish. In another embodiment, lever mounted game feeder 100 can be used to feed nongame animals such as livestock or chicken.

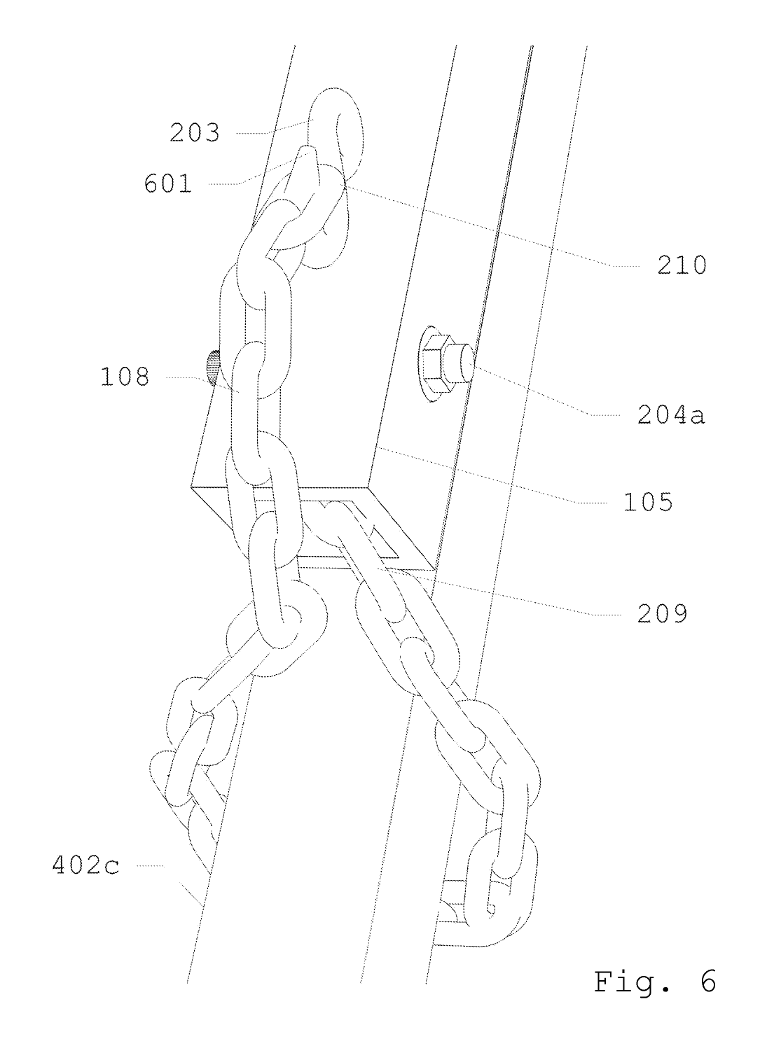

FIG. 6 illustrates a detailed view of first chain 108 holding lever mounted game feeder system 100 in the up position. Hook 203 can comprise a hook point 601. In one embodiment, first end 105 can be secured to second segment 402c. In one embodiment, first chain 108 can be used to secure first end 105 to second segment 402c. For example, in one embodiment, first end 209 is attached to first end 105, first chain 108 is thereafter wrapped around second segment 402c, and second end 210 is attached to first hook 203, as shown in FIG. 6. In one embodiment, bolt assembly 204a can be threaded through first end 209 and first end 105 in order to attach first chain 108 to first end 105. In one embodiment, second end 210 can be attached to first hook 203 by inserting hook point 601 through a link in second end 210. In one embodiment, first end 105 can be more securely attached to second segment 402c by removing as much slack from first chain 108 as possible prior to attaching second end 210 to first hook 203. In another embodiment, a rope or line may be used to serve the purposes of second chain 108. In another embodiment, first end 105 can be lowered and secured to second segment 402c by attaching a line to first end 105 and the opposite end of the line to a winch attached to second segment 402c. In one embodiment, the winch can also include a manual crank, winch safety system, and winch release. In one embodiment, the winch can be raised, lowered, and locked by a non-human power source. For example, in one embodiment, an electric motor may be engaged to rotate the winch. In one embodiment, the winch may be operated by a combination of human power sources and non-human power sources. In another embodiment, a handle can be attached to second end 210 in order to provide a grip to users pulling down first end 105.

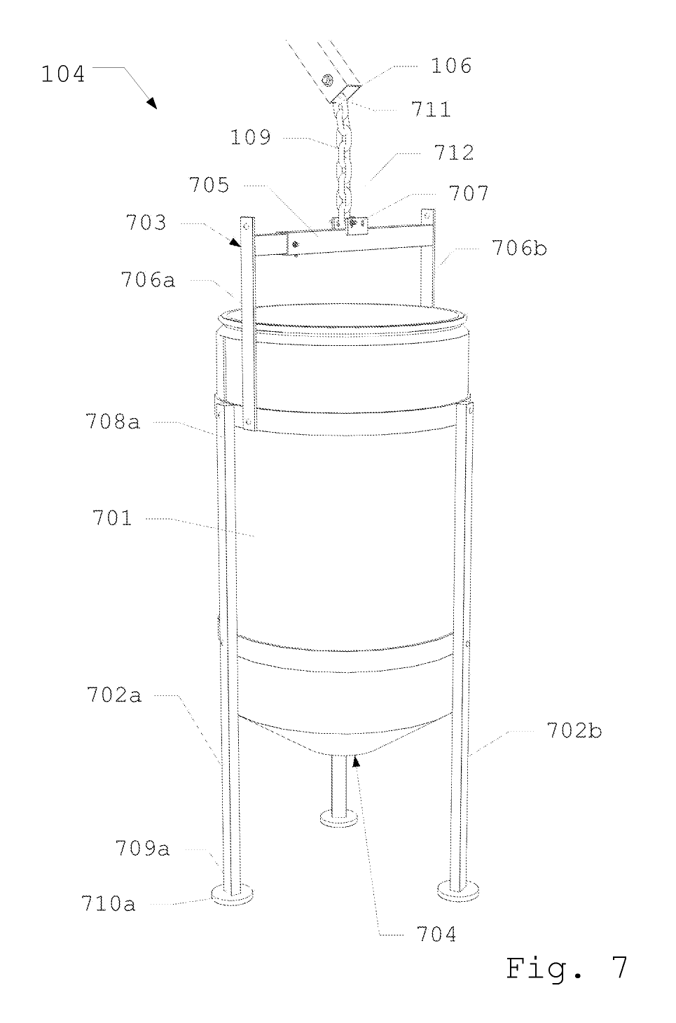

FIG. 7 illustrates hanging feeder container assembly 104. Hanging feeder container assembly 104 can comprise a feeder container 701, one or more feeder legs 702, a hanger assembly 703, and a broadcaster 704. Feeder legs 702 can comprise a first leg 702a, a second leg 702b, and a third leg 702b. Hanger assembly 703 can comprise a crossbar assembly 705, one or more arms 706, and a bracketing system 707. Each feeder leg 703 can comprise a first end 708, a second end 709, and a foot 710. In one embodiment, feeder legs 703 can protect broadcaster 704 from damage caused by the ground or other items below hanging feeder container assembly 104. Second chain 109 can comprise a first end 711 and a second end 712. In one embodiment, arms 703 can attach to feeder container 701 at one end and attach to crossbar assembly 705 at their other ends. Further, in such embodiment, bracketing system can be attached substantially to the midpoint of crossbar assembly 705. In one embodiment, second end 712 can be attached to bracketing system 707, and first end 711 can be attached to second end 106.

Various changes in the details of the illustrated operational methods are possible without departing from the scope of the following claims, Some embodiments may combine the activities described herein as being separate steps, Similarly, one or more of the described steps may be omitted, depending upon the specific operational environment the method is being implemented in. It is to be understood that the above description is intended to be illustrative, and not restrictive, For example, the above-described embodiments may be used in combination with each other, Many other embodiments will be apparent to those of skill in the art upon reviewing the above description, The scope of the invention should, therefore, be determined with reference to the appended claims, along with the full scope of equivalents to which such claims are entitled, In the appended claims, the terms “including” and “in which” are used as the plain- English equivalents of the respective terms “comprising” and “wherein.”

1. A game feeder system comprising,
a lever comprising a first end, a second end, and a fulcrum point;
one or more legs each comprising a first end and a second end; and
a core attached to said fulcrum point and to said legs.

2. The game feeder of claim 1 further comprising a first connector.

3. The game feeder of claim 2 wherein said first connector binds said first end of said lever to a ground.

4. The game feeder of claim 2 wherein said first connector binds said first end of said lever to a first leg.

5. The game feeder of claim 4 wherein said first connector is a first line having a first end and a second end, further wherein said first end of said first line is attached to said first end of said lever.

6. The game feeder of claim 5 wherein said first line substantially comprises a chain.

7. The game feeder of claim 5 further comprising a handle attached to said second end of first line.

8. The game feeder of claim 5 wherein said second end of said first line is attached to a winch.

9. The game feeder of claim 8 wherein said winch is attached to said first leg.

10. The game feeder of claim 8 wherein said winch comprises a safety mechanism to control the release of said first line.

11. The game feeder of claim 1 further comprising a second connector.

12. The game feeder of claim 11 wherein said second connector is capable of binding a second end of said lever to a load.

13. The lever of claim 12 wherein said load comprises a hanging feeder container assembly.

14. The lever of claim 12 wherein said load comprises an animal.

15. The legs of claim 1 wherein said legs comprise a first segment and a second segment attached by a junction assembly.

16. The legs of claim 1 wherein at least one of said legs each comprise an anchor point attached to said second end of said legs.

17. The anchor point of claim 16 wherein said anchor points are capable of receiving a stake wherein said stake is driven into the ground.

18. The game feeder of claim 1 wherein said lever comprises rectangular tubing.

19. The game feeder of claim 1 wherein said core comprises
a platform comprising a top side and a bottom side;
one or more core towers attached to said top side of said platform;
one or more tower holes in said core towers; and
one or more core legs attached to said bottom side of said platform.

20. The game feeder of claim 19 wherein a bolt assembly attaches said lever to said core through said tower holes.

21. The game feeder of claim 20 wherein said bolt assembly serves as said fulcrum point.

22. The game feeder of claim 19 wherein said first end of said legs are inserted into said core legs.
